(19) United States
(12) Patent Application Publication
(10) Pub. No.: US 2019/0149205 A1
(43) Pub. Date: May 16, 2019

(54) METHOD FOR TRANSMITTING UPLINK SIGNAL IN DISTRIBUTED ANTENNA COMMUNICATION SYSTEM AND DEVICE FOR SAME

(71) Applicant: LG ELECTRONICS INC., Seoul (KR)

(72) Inventors: Heejin KIM, Seoul (KR); Jiwon KANG, Seoul (KR); Heejeong CHO, Seoul (KR); Genebeck HAHN, Seoul (KR); Ilmu BYUN, Seoul (KR); Hyunjin SHIM, Seoul (KR)

(73) Assignee: LG ELECTRONICS INC., Seoul (KR)

(21) Appl. No.: 16/302,077

(22) PCT Filed: Jan. 12, 2017
(86) PCT No.: PCT/KR2017/000407

§ 371 Date: Nov. 15, 2018

Related U.S. Application Data
(60) Provisional application No. 62/342,186, filed on May 26, 2016.

(51) Int. Cl. H04B 7/0456; H04B 7/0404

(52) U.S. Cl. CPC H04B 7/0473; H04B 7/0404

(57) ABSTRACT

Disclosed is a method for a terminal, which comprises a plurality of distributed antenna units, transmitting an uplink signal comprising a plurality of codewords in a wireless communication system. More particularly, the method comprises the steps of: receiving, from a base station, control information for an uplink signal; mapping a plurality of codewords to a plurality of layers in accordance with an indicator comprised in the control information; precoding the layer-mapped codewords; and transmitting the uplink signal comprising the precoded codewords to the base station, wherein the indicator indicates one of the two or more codeword-to-layer mapping rules corresponding to the number of the layers.

### TECHNICAL FIELD

The present invention relates to a wireless communication system, and more particularly, to a method for transmitting an uplink signal in a distributed antenna communication system and a device for the same.

### BACKGROUND ART

3GPP LTE (3rd generation partnership project long term evolution hereinafter abbreviated LTE) communication system is schematically explained as an example of a wireless communication system to which the present invention is applicable.

FIG. 1 is a schematic diagram of E-UMTS network structure as one example of a wireless communication system. E-UMTS (evolved universal mobile telecommunications system) is a system evolved from a conventional UMTS (universal mobile telecommunications system). Currently, basic standardization works for the E-UMTS are in progress by 3GPP. E-UMTS is called LTE system in general. Detailed contents for the technical specifications of UMTS and E-UMTS refers to release 7 and release 8 of “3rd generation partnership project; technical specification group radio access network”, respectively.

Referring to FIG. 1, E-UMTS includes a user equipment (UE), an eNode B (eNB), and an access gateway (hereinafter abbreviated AG) connected to an external network in a manner of being situated at the end of a network (E-UTRAN). The eNode B may be able to simultaneously transmit multi data streams for a broadcast service, a multicast service and/or a unicast service.

One eNode B contains at least one cell. The cell provides a downlink transmission service or an uplink transmission service to a plurality of user equipments by being set to one of 1.25 MHz, 2.5 MHz, 5 MHz, 10 MHz, 15 MHz, and 20 MHz of bandwidths. Different cells can be configured to provide corresponding bandwidths, respectively. An eNode B controls data transmissions/receptions to/from a plurality of the user equipments. For a downlink (hereinafter abbreviated DL) data, the eNode B informs a corresponding user equipment of time/frequency region on which data is transmitted, coding, data size, HARQ (hybrid automatic repeat and request) related information and the like by transmitting DL scheduling information. And, for an uplink (hereinafter abbreviated UL) data, the eNode B informs a corresponding user equipment of time/frequency region usable by the corresponding user equipment, coding, data size, HARQ-related information and the like by transmitting UL scheduling information to the corresponding user equipment. Interfaces for user-traffic transmission or control traffic transmission may be used between eNode Bs. A core network (CN) consists of an AG (access gateway) and a network node for user registration of a user equipment and the like. The AG manages a mobility of the user equipment by a unit of TA (tracking area) consisting of a plurality of cells.

Wireless communication technologies have been developed up to LTE based on WCDMA. Yet, the ongoing demands and expectations of users and service providers are consistently increasing. Moreover, since different kinds of radio access technologies are continuously developed, a new technological evolution is required to have a future competitiveness. Cost reduction per bit, service availability increase, flexible frequency band use, simple structure/open interface and reasonable power consumption of user equipment and the like are required for the future competitiveness.

### DISCLOSURE

### Technical Problem

Based on the aforementioned discussion, an object of the present invention is to provide a method for transmitting an uplink signal in a distributed antenna communication system and a device for the same.

### Technical Solution

A method for a user equipment (UE), which comprises a plurality of distributed antenna units, transmitting an uplink signal comprising a plurality of codewords in a wireless communication system according to one aspect of the present invention comprises the steps of: receiving, from a base station, control information for the uplink signal; mapping the plurality of codewords into a plurality of layers in accordance with an indicator included in the control information; precoding the layer-mapped codewords; and transmitting the uplink signal comprising the precoded codewords to the base station, wherein the indicator indicates one of two or more codeword-to-layer mapping rules corresponding to the number of the layers.

Meanwhile, a user equipment (UE) in a wireless communication system according to one aspect of the present invention comprises a plurality of distributed antenna units; and a processor connected with the plurality of distributed antenna units, wherein the processor receives, from a base station, control information for an uplink signal comprising a plurality of codewords, maps the plurality of codewords into a plurality of layers in accordance with an indicator included in the control information, precodes the layer-mapped codewords, and transmits the uplink signal comprising the precoded codewords to the base station, and wherein the indicator indicates one of two or more codeword-to-layer mapping rules corresponding to the number of the layers.

Preferably, the two or more codeword-to-layer mapping rules include a specific mapping rule in which one codeword is mapped into one layer and the other one codeword is mapped into the other layers.

More preferably, layer permutation may be applied to the layer-mapped codewords on a layer group basis, and in this case, the layer group is defined as a layer of a rank size per distributed antenna unit. Additionally, the precoding may be applied to the codewords to which layer permutation is applied.

More preferably, information for the layer permutation and information on a rank size per distributed antenna unit may be included in the control information.

Additionally, antenna port configuration information per distributed antenna may be provided from the UE to the base station.

### Advantageous Effects

According to the embodiment of the present invention, an uplink signal may be transmitted more efficiently in accordance with a codeword-to-layer mapping rule for a distributed antenna communication system.

It will be appreciated by persons skilled in the art that the effects that can be achieved with the present invention are not limited to what has been particularly described hereinabove and other advantages of the present invention will be more clearly understood from the following detailed description taken in conjunction with the accompanying drawings.

### BRIEF DESCRIPTION OF THE DRAWINGS

FIG. 1 is a diagram schematically illustrating a network structure of an E-UMTS as an exemplary radio communication system.

FIG. 2 is a diagram illustrating structures of a control plane and a user plane of a radio interface protocol between a UE and an E-UTRAN based on the 3GPP radio access network specification.

FIG. 3 is a diagram illustrating physical channels used in a 3GPP system and a general signal transmission method using the same.

FIG. 4 is a diagram illustrating the structure of a radio frame used in an LTE system.

FIG. 5 is a diagram illustrating the structure of a DL radio frame used in an LTE system.

FIG. 6 is a diagram illustrating the structure of a UL subframe in an LTE system.

FIG. 7 illustrates the configuration of a typical MIMO communication system.

FIG. 8 illustrates an example of MIMO antenna transmission of a PUSCH in an LTE system.

FIG. 9 is a diagram illustrating a concept of a codeword-to-layer mapping in an LTE system.

FIG. 10 is a diagram illustrating a vehicle comprising a plurality of antenna arrays.

FIG. 11 is a diagram illustrating an example of function sharing between a DU and a CU in a vehicle MIMO system.

FIG. 12 is a diagram illustrating a problem that may occur when the legacy CLM rule is applied to a vehicle distributed antenna system.

FIGS. 13 and 14 are diagrams illustrating a method for providing a CLM indicator in accordance with the first embodiment of the present invention.

FIG. 15 is an example of layer permutation according to the second embodiment of the present invention.

FIG. 16 is a configuration example of an RU based layer permutation matrix according to the second embodiment of the present invention.

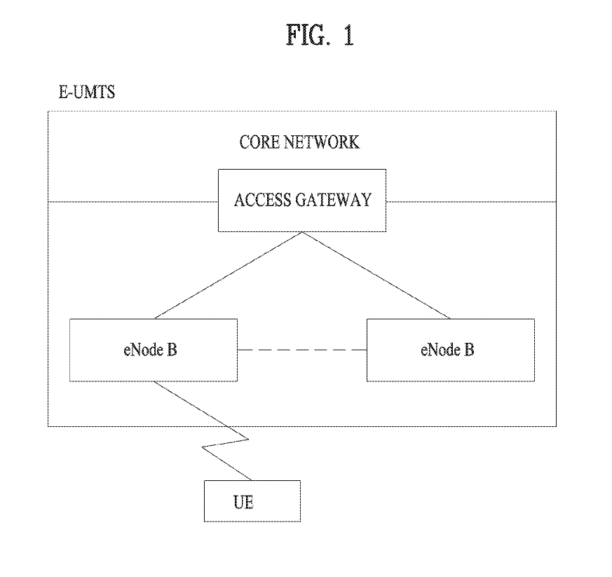

### BEST MODE FOR CARRYING OUT THE INVENTION

The configuration, operation, and other features of the present invention will readily be understood with embodiments of the present invention described with reference to the attached drawings. Embodiments of the present invention as set forth herein are examples in which the technical features of the present invention are applied to a 3rd Generation Partnership Project (3GPP) system.

While embodiments of the present invention are described in the context of Long Term Evolution (LTE) and LTE-Advanced (LTE-A) systems, they are purely exemplary. Therefore, the embodiments of the present invention are applicable to any other communication system as long as the above definitions are valid for the communication system. In addition, while the embodiments of the present invention are described in the context of Frequency Division Duplexing (FDD), they are also readily applicable to Half-FDD (H-FDD) or Time Division Duplexing (TDD) with some modifications.

The term ‘Base Station (BS)’ may be used to cover the meanings of terms including Remote Radio Head (RRH), evolved Node B (eNB or eNode B), Reception Point (RP), relay, etc.

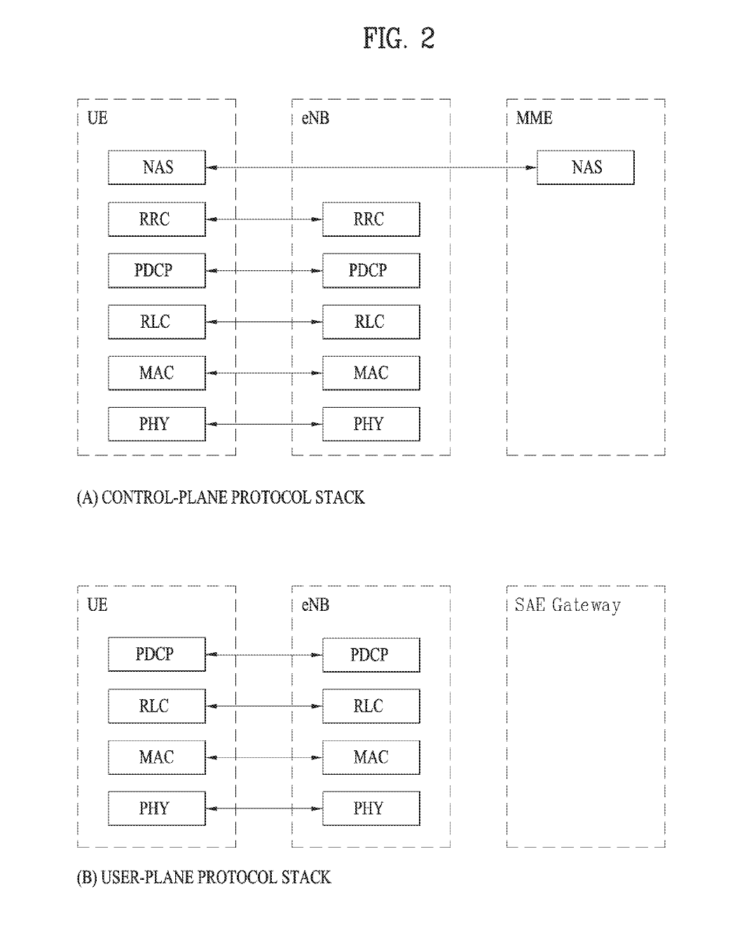

FIG. 2 illustrates control-plane and user-plane protocol stacks in a radio interface protocol architecture conforming to a 3GPP wireless access network standard between a User Equipment (UE) and an Evolved UMTS Terrestrial Radio Access Network (E-UTRAN). The control plane is a path in which the UE and the E-UTRAN transmit control messages to manage calls, and the user plane is a path in which data generated from an application layer, for example, voice data or Internet packet data is transmitted.

A PHYsical (PHY) layer at Layer 1 (L1) provides information transfer service to its higher layer, a Medium Access Control (MAC) layer. The PHY layer is connected to the MAC layer via transport channels. The transport channels deliver data between the MAC layer and the PHY layer. Data is transmitted on physical channels between the PHY layers of a transmitter and a receiver. The physical channels use time and frequency as radio resources. Specifically, the physical channels are modulated in Orthogonal Frequency Division Multiple Access (OFDMA) for Downlink (DL) and in Single Carrier Frequency Division Multiple Access (SC-FDMA) for Uplink (UL).

The MAC layer at Layer 2 (L2) provides service to its higher layer, a Radio Link Control (RLC) layer via logical channels. The RLC layer at L2 supports reliable data transmission. RLC functionality may be implemented in a function block of the MAC layer. A Packet Data Convergence Protocol (PDCP) layer at L2 performs header compression to reduce the amount of unnecessary control information and thus efficiently transmit Internet Protocol (IP) packets such as IP version 4 (IPv4) or IP version 6 (IPv6) packets via an air interface having a narrow bandwidth.

A Radio Resource Control (RRC) layer at the lowest part of Layer 3 (or L3) is defined only on the control plane. The RRC layer controls logical channels, transport channels, and physical channels in relation to configuration, reconfiguration, and release of radio bearers. A radio bearer refers to a service provided at L2, for data transmission between the UE and the E-UTRAN. For this purpose, the RRC layers of the UE and the E-UTRAN exchange RRC messages with each other. If an RRC connection is established between the UE and the E-UTRAN, the UE is in RRC Connected mode and otherwise, the UE is in RRC Idle mode. A Non-Access Stratum (NAS) layer above the RRC layer performs functions including session management and mobility management.

One cell constituting an eNB provides a downlink transmission service or an uplink transmission service to a plurality of user equipments by being set to one of 1.25 MHz, 2.5 MHz, 5 MHz, 10 MHz, 15 MHz, and 20 MHz of bandwidths. Different cells may be configured to provide corresponding bandwidths, respectively.

DL transport channels used to deliver data from the E-UTRAN to UEs include a Broadcast Channel (BCH) carrying system information, a Paging Channel (PCH) carrying a paging message, and a Shared Channel (SCH) carrying user traffic or a control message. DL multicast traffic or control messages or DL broadcast traffic or control messages may be transmitted on a DL SCH or a separately defined DL Multicast Channel (MCH). UL transport channels used to deliver data from a UE to the E-UTRAN include a Random Access Channel (RACH) carrying an initial control message and a UL SCH carrying user traffic or a control message. Logical channels that are defined above transport channels and mapped to the transport channels include a Broadcast Control Channel (BCCH), a Paging Control Channel (PCCH), a Common Control Channel (CCCH), a Multicast Control Channel (MCCH), a Multicast Traffic Channel (MTCH), etc.

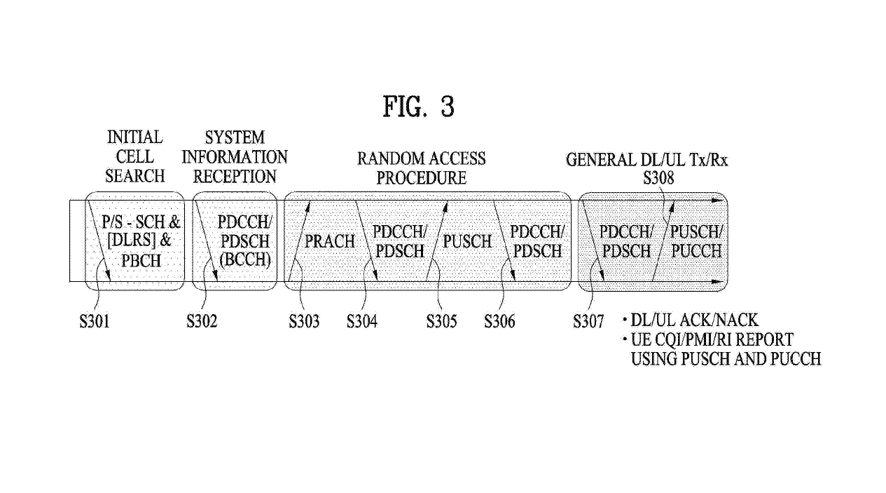

FIG. 3 illustrates physical channels and a general method for transmitting signals on the physical channels in the 3GPP system.

Referring to FIG. 3, when a UE is powered on or enters a new cell, the UE performs initial cell search (S301). The initial cell search involves acquisition of synchronization to an eNB. Specifically, the UE synchronizes its timing to the eNB and acquires a cell Identifier (ID) and other information by receiving a Primary Synchronization Channel (P-SCH) and a Secondary Synchronization Channel (S-SCH) from the eNB. Then the UE may acquire information broadcast in the cell by receiving a Physical Broadcast Channel (PBCH) from the eNB. During the initial cell search, the UE may monitor a DL channel state by receiving a DownLink Reference Signal (DL RS).

After the initial cell search, the UE may acquire detailed system information by receiving a Physical Downlink Control Channel (PDCCH) and receiving a Physical Downlink Shared Channel (PDSCH) based on information included in the PDCCH (S302).

If the UE initially accesses the eNB or has no radio resources for signal transmission to the eNB, the UE may perform a random access procedure with the eNB (S303 to S306). In the random access procedure, the UE may transmit a predetermined sequence as a preamble on a Physical Random Access Channel (PRACH) (S303 and S305) and may receive a response message to the preamble on a PDCCH and a PDSCH associated with the PDCCH (S304 and S306). In the case of a contention-based RACH, the UE may additionally perform a contention resolution procedure.

After the above procedure, the UE may receive a PDCCH and/or a PDSCH from the eNB (S307) and transmit a Physical Uplink Shared Channel (PUSCH) and/or a Physical Uplink Control Channel (PUCCH) to the eNB (S308), which is a general DL and UL signal transmission procedure. Particularly, the UE receives Downlink Control Information (DCI) on a PDCCH. Herein, the DCI includes control information such as resource allocation information for the UE. Different DCI formats are defined according to different usages of DCI.

Control information that the UE transmits to the eNB on the UL or receives from the eNB on the DL includes a DL/UL ACKnowledgment/Negative ACKnowledgment (ACK/NACK) signal, a Channel Quality Indicator (CQI), a Precoding Matrix Index (PMI), a Rank Indicator (RI), etc. In the 3GPP LTE system, the UE may transmit control information such as a CQI, a PMI, an RI, etc. on a PUSCH and/or a PUCCH.

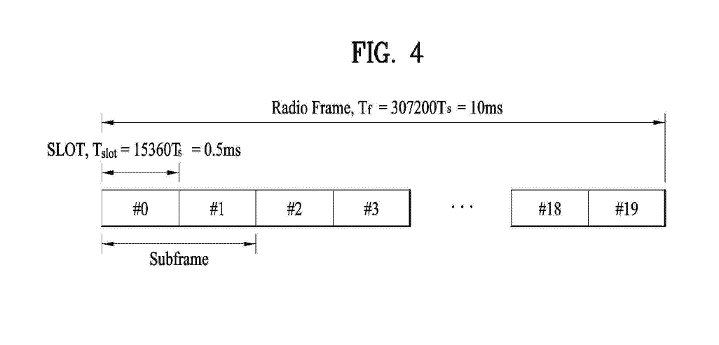

FIG. 4 illustrates a structure of a radio frame used in the LTE system.

Referring to FIG. 4, a radio frame is 10 ms (327200×Tₛ) long and divided into 10 equal-sized subframes. Each subframe is 1 ms long and further divided into two slots. Each time slot is 0.5 ms (15360×Tₛ) long. Herein, Tₛ represents a sampling time and Tₛ=1/(15 kHz×2048)=3.2552×10⁻⁸ (about 33 ns). A slot includes a plurality of Orthogonal Frequency Division Multiplexing (OFDM) symbols or SC-FDMA symbols in the time domain by a plurality of Resource Blocks (RBs) in the frequency domain. In the LTE system, one RB includes 12 subcarriers by 7 (or 6) OFDM symbols. A unit time during which data is transmitted is defined as a Transmission Time Interval (TTI). The TTI may be defined in units of one or more subframes. The above-described radio frame structure is purely exemplary and thus the number of subframes in a radio frame, the number of slots in a subframe, or the number of OFDM symbols in a slot may vary.

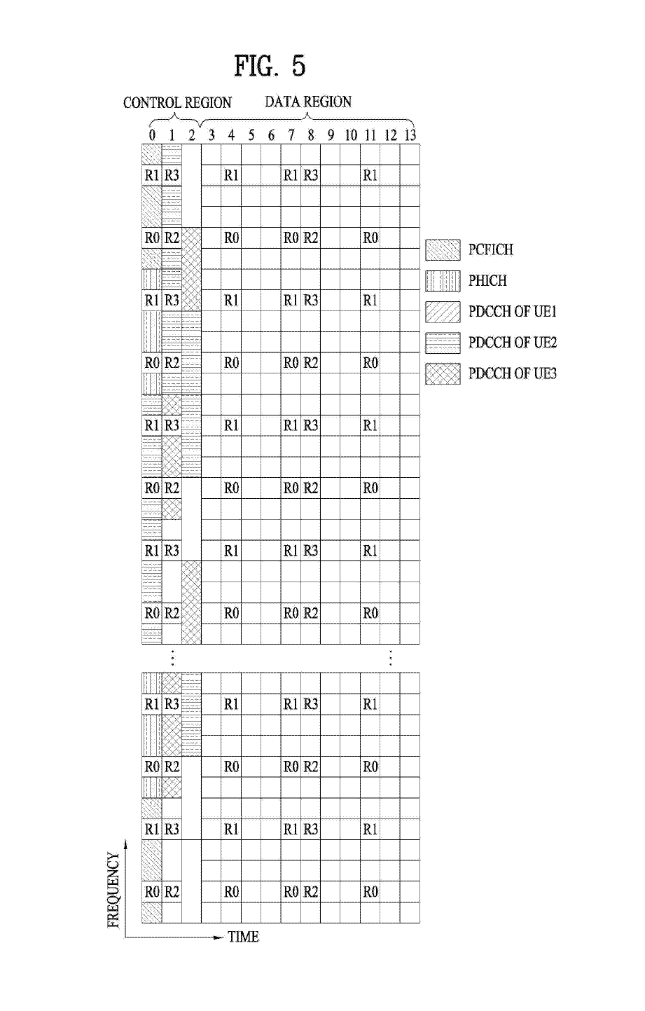

FIG. 5 illustrates exemplary control channels included in a control region of a subframe in a DL radio frame.

Referring to FIG. 5, a subframe includes 14 OFDM symbols. The first one to three OFDM symbols of a subframe are used for a control region and the other 13 to 11 OFDM symbols are used for a data region according to a subframe configuration. In FIG. 5, reference characters R1 to R4 denote RSs or pilot signals for antenna 0 to antenna 3. RSs are allocated in a predetermined pattern in a subframe irrespective of the control region and the data region. A control channel is allocated to non-RS resources in the control region and a traffic channel is also allocated to non-RS resources in the data region. Control channels allocated to the control region include a Physical Control Format Indicator Channel (PCFICH), a Physical Hybrid-ARQ Indicator Channel (PHICH), a Physical Downlink Control Channel (PDCCH), etc.

The PCFICH is a physical control format indicator channel carrying information about the number of OFDM symbols used for PDCCHs in each subframe. The PCFICH is located in the first OFDM symbol of a subframe and configured with priority over the PHICH and the PDCCH. The PCFICH includes 4 Resource Element Groups (REGs), each REG being distributed to the control region based on a cell Identity (ID). One REG includes 4 Resource Elements (REs). An RE is a minimum physical resource defined by one subcarrier by one OFDM symbol. The PCFICH is set to 1 to 3 or 2 to 4 according to a bandwidth. The PCFICH is modulated in Quadrature Phase Shift Keying (QPSK).

The PHICH is a physical Hybrid-Automatic Repeat and request (HARQ) indicator channel carrying an HARQ ACK/NACK for a UL transmission. That is, the PHICH is a channel that delivers DL ACK/NACK information for UL HARQ. The PHICH includes one REG and is scrambled cell-specifically. An ACK/NACK is indicated in one bit and modulated in Binary Phase Shift Keying (BPS K). The modulated ACK/NACK is spread with a Spreading Factor (SF) of 2 or 4. A plurality of PHICHs mapped to the same resources form a PHICH group. The number of PHICHs multiplexed into a PHICH group is determined according to the number of spreading codes. A PHICH (group) is repeated three times to obtain diversity gain in the frequency domain and/or the time domain.

The PDCCH is a physical DL control channel allocated to the first n OFDM symbols of a subframe. Herein, n is 1 or a larger integer indicated by the PCFICH. The PDCCH occupies one or more CCEs. The PDCCH carries resource allocation information about transport channels, PCH and DL-SCH, a UL scheduling grant, and HARQ information to each UE or UE group. The PCH and the DL-SCH are transmitted on a PDSCH. Therefore, an eNB and a UE transmit and receive data usually on the PDSCH, except for specific control information or specific service data.

Information indicating one or more UEs to receive PDSCH data and information indicating how the UEs are supposed to receive and decode the PDSCH data are delivered on a PDCCH. For example, on the assumption that the Cyclic Redundancy Check (CRC) of a specific PDCCH is masked by Radio Network Temporary Identity (RNTI) “A” and information about data transmitted in radio resources (e.g. at a frequency position) “B” based on transport format information (e.g. a transport block size, a modulation scheme, coding information, etc.) “C” is transmitted in a specific subframe, a UE within a cell monitors, that is, blind-decodes a PDCCH using its RNTI information in a search space. If one or more UEs have RNTI “A”, these UEs receive the PDCCH and receive a PDSCH indicated by “B” and “C” based on information of the received PDCCH.

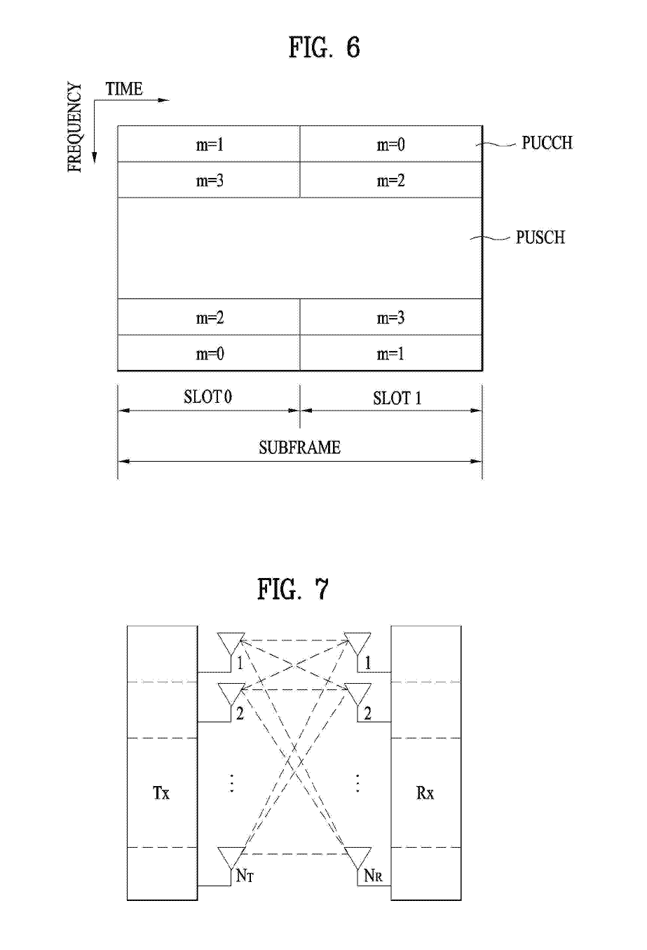

FIG. 6 illustrates a structure of a UL subframe in the LTE system.

Referring to FIG. 6, a UL subframe may be divided into a control region and a data region. A Physical Uplink Control Channel (PUCCH) including Uplink Control Information (UCI) is allocated to the control region and a Physical uplink Shared Channel (PUSCH) including user data is allocated to the data region. The middle of the subframe is allocated to the PUSCH, while both sides of the data region in the frequency domain are allocated to the PUCCH. Control information transmitted on the PUCCH may include an HARQ ACK/NACK, a CQI representing a downlink channel state, an RI for Multiple Input Multiple Output (MIMO), a Scheduling Request (SR) requesting UL resource allocation. A PUCCH for one UE occupies one RB in each slot of a subframe. That is, the two RBs allocated to the PUCCH are frequency-hopped over the slot boundary of the subframe. Particularly, PUCCHs with m=0, m=1, and m=2 are allocated to a subframe in FIG. 6.

Hereinafter, a MIMO system will be described. MIMO refers to a method using multiple transmit antennas and multiple receive antennas to improve data transmission/reception efficiency. Namely, a plurality of antennas is used at a transmitter or a receiver of a wireless communication system so that capacity can be increased and performance can be improved. MIMO may also be referred to as multi-antenna in this disclosure.

MIMO technology does not depend on a single antenna path in order to receive a whole message. Instead, MIMO technology completes data by combining data fragments received via multiple antennas. The use of MIMO technology can increase data transmission rate within a cell area of a specific size or extend system coverage at a specific data transmission rate. MIMO technology can be widely used in mobile communication terminals and relay nodes. MIMO technology can overcome a limited transmission capacity encountered with the conventional single-antenna technology in mobile communication.

FIG. 7 illustrates the configuration of a typical MIMO communication system.

A transmitter has N_{T} transmit (Tx) antennas and a receiver has N_{R} receive (Rx) antennas. Use of a plurality of antennas at both the transmitter and the receiver increases a theoretical channel transmission capacity, compared to the use of a plurality of antennas at only one of the transmitter and the receiver. Channel transmission capacity increases in proportion to the number of antennas. Therefore, transmission rate and frequency efficiency are increased. Given a maximum transmission rate Rₒ that may be achieved with a single antenna, the transmission rate may be increased, in theory, to the product of Rₒ and a transmission rate increase rate Rᵢ in the case of multiple antennas, as indicated by Equation 1. Rᵢ is the smaller of N_{T} and N_{R}.

Rᵢ=min(N_{T},N_{R}) [Equation 1]

For example, a MIMO communication system with four Tx antennas and four Rx antennas may theoretically achieve a transmission rate four times that of a single antenna system. Since the theoretical capacity increase of the MIMO wireless communication system was verified in the mid-1990s, many techniques have been actively developed to increase data transmission rate in real implementations. Some of these techniques have already been reflected in various wireless communication standards including standards for 3rd generation (3G) mobile communications, next-generation wireless local area networks, etc.

Active research up to now related to MIMO technology has focused upon a number of different aspects, including research into information theory related to MIMO communication capacity calculation in various channel environments and in multiple access environments, research into wireless channel measurement and model derivation of MIMO systems, and research into space-time signal processing technologies for improving transmission reliability and transmission rate.

Communication in a MIMO system will be described in detail through mathematical modeling. It is assumed that N_{T} Tx antennas and N_{R} Rx antennas are present as illustrated in FIG. 7. Regarding a transmission signal, up to N_{T} pieces of information can be transmitted through the N_{T} Tx antennas, as expressed as the following vector.

s=[s₁,s₂, . . . ,s_{N}_{_{T}}]^{T} [Equation 2]

Individual pieces of the transmission information s₁, s₂, . . . , s_{N}_{_{T}} may have different transmit powers. If the individual transmit powers are denoted by P₁, P₂, . . . P_{N}_{_{T}}, respectively, then the transmission power-controlled transmission information may be given as

ŝ=[ŝ₁,ŝ₂, . . . ŝ_{N}_{_{T}}]^{T}=[P₁s₁,P₂s₂, . . . P_{N}_{_{T}}s_{N}_{_{T}}]^{T} [Equation 3]

The transmission power-controlled transmission information vector ŝ may be expressed below, using a diagonal matrix P of transmission power.

$$\hat{s} = [ \begin{matrix}{P}_{1} & & & 0 \\ & {P}_{2} & & \\ & & ⋱ & \\ 0 & & & {P}_{{N}_{T}}\end{matrix} ] [ \begin{matrix}{s}_{1} \\ {s}_{2} \\ ⋮ \\ {s}_{{N}_{T}}\end{matrix} ] = Ps \qquad [ Equation 4 ]$$

Meanwhile, N_{T} transmission signals x₁, x₂, . . . , x_{N}_{_{T}} to be actually transmitted may be configured by multiplying the transmission power-controlled information vector ŝ by a weight matrix W. The weight matrix W functions to appropriately distribute the transmission information to individual antennas according to transmission channel states, etc. The transmission signals x₁, x₂, . . . , x_{N}_{_{T}} are represented as a vector X, which may be determined by Equation 5. Here, Wᵢⱼ denotes a weight of an i-th Tx antenna and a j-th piece of information. W is referred to as a weight matrix or a precoding matrix.

$$x = [ \begin{matrix}{x}_{1} \\ {x}_{2} \\ ⋮ \\ {x}_{i} \\ ⋮ \\ {x}_{{N}_{T}}\end{matrix} ] = [ \begin{matrix}{w}_{11} & {w}_{12} & … & {w}_{1 {N}_{T}} \\ {w}_{21} & {w}_{22} & … & {w}_{2 {N}_{T}} \\ ⋮ & & ⋱ & \\ {w}_{i 1} & {w}_{i 2} & … & {w}_{{iN}_{T}} \\ ⋮ & & ⋱ & \\ {w}_{{N}_{T} 1} & {w}_{{N}_{T} 2} & … & {w}_{{N}_{T} {N}_{T}}\end{matrix} ] [ \begin{matrix}{\hat{s}}_{1} \\ {\hat{s}}_{2} \\ ⋮ \\ {\hat{s}}_{j} \\ ⋮ \\ {\hat{s}}_{{N}_{T}}\end{matrix} ] = W \hat{s} = WPs \qquad [ Equation 5 ]$$

Generally, the physical meaning of the rank of a channel matrix is the maximum number of different pieces of information that can be transmitted on a given channel. Therefore, the rank of a channel matrix is defined as the smaller of the number of independent rows and the number of independent columns in the channel matrix. Accordingly, the rank of the channel matrix is not larger than the number of rows or columns of the channel matrix. The rank of the channel matrix H (rank(H)) is restricted as follows.

rank(H)≤min(N_{T},N_{R}) [Equation 6]

A different piece of information transmitted in MIMO is referred to as a transmission stream or stream. A stream may also be called a layer. It is thus concluded that the number of transmission streams is not larger than the rank of channels, i.e. the maximum number of different pieces of transmittable information. Thus, the channel matrix H is determined by

# of streams≤rank(H)≤min(N_{T},N_{R}) [Equation 7]

“# of streams” denotes the number of streams. It should be noted that one stream may be transmitted through one or more antennas.

One or more streams may be mapped to a plurality of antennas in many ways. This method may be described as follows depending on MIMO schemes. If one stream is transmitted through a plurality of antennas, this may be regarded as spatial diversity. When a plurality of streams is transmitted through a plurality of antennas, this may be spatial multiplexing. A hybrid scheme of spatial diversity and spatial multiplexing may be contemplated.

MIMO antenna transmission of the above-described LTE system supports an uplink as well as a downlink. Particularly, data transmission through a PUSCH aims to increase data throughput and frequency efficiency through precoding that supports multiplexing to reach a maximum of 4 layers. Moreover, a control channel may aim to increase reliability of a PUCCH as the PUCCH supports a transmit diversity.

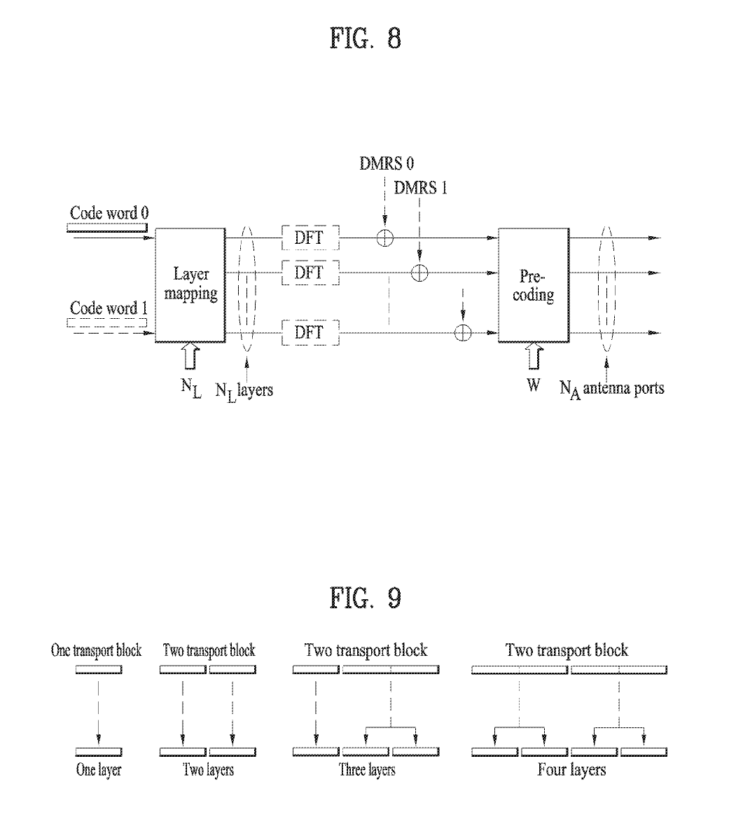

FIG. 8 illustrates an example of MIMO antenna transmission of a PUSCH in an LTE system.

Referring to FIG. 8, it is noted that a maximum of two codewords are subjected to MIMO antenna transmission through a maximum of four layers and one precoded reference signal, for example, DM-RS is transmitted per one layer. Particularly, the LTE system may support a maximum of four antenna ports.

FIG. 9 is a diagram illustrating a concept of a codeword-to-layer mapping in an LTE system. A codeword-to-layer mapping concept of FIG. 9 is summarized as listed in Table 1 below. In Table 1, P indicates the number of antenna ports used for PUSCH transmission, and ν indicates the number of layers.

TABLE 1

| Num- | | | |
|---|---|---|---|
| ber of | Number of | Codeword-to-layer mapping | |
| layers | codewords | i = 0, 1, . . . , M_{symb}^{layer} − 1 | |
| 1 | 1 | x⁽⁰⁾(i) = d⁽⁰⁾(i) | M_{symb}^{layer} = M_{symb}⁽⁰⁾ |
| 2 | 1 | x⁽⁰⁾(i) = d⁽⁰⁾(2i) | M_{symb}^{layer} = M_{symb}⁽⁰⁾/2 |
| | | x⁽¹⁾(i) = d⁽⁰⁾(2i + 1) | |
| 2 | 2 | x⁽⁰⁾(i) = d⁽⁰⁾(i) | M_{symb}^{layer} = M_{symb}⁽⁰⁾ = M_{symb}⁽¹⁾ |
| | | x⁽¹⁾(i) = d⁽¹⁾(i) | |
| 3 | 2 | x⁽⁰⁾(i) = d⁽⁰⁾(i) | M_{symb}^{layer} = |
| | | x⁽¹⁾(i) = d⁽¹⁾(2i) | M_{symb}⁽⁰⁾ = M_{symb}⁽¹⁾/2 |
| | | x⁽²⁾(i) = d⁽¹⁾(2i + 1) | |
| 4 | 2 | x⁽⁰⁾(i) = d⁽⁰⁾(2i) | M_{symb}^{layer} = |
| | | x⁽¹⁾(i) = d⁽⁰⁾(2i + 1) | M_{symb}⁽⁰⁾/2 = M_{symb}⁽¹⁾/2 |
| | | x⁽²⁾(i) = d⁽¹⁾(2i) | |
| | | x⁽³⁾(i) = d⁽¹⁾(2i + 1) | |

Meanwhile, for proper selection of a precoder which will be used for uplink MIMO antenna transmission, the eNB, that is, the network needs information on an uplink channel. This information may be measured through a sounding reference signal, which is a non-precoded reference signal. The network may select the number of ranks and layers for the corresponding UE, precoder, proper MCS level per codeword, etc. through the measured uplink information and provide the selected data through DCI.

Hereinafter, measurement and reporting of Channel Status Information (CSI) will be described.

To generate beams suitable for signal reception of the receiver, the transmitter should identify information on a channel between the transmitter and the receiver and exactly measure proper beams and gain during the use of the beams based on the identified information. Although the channel information may be measured in a way that the receiver transmits a separate pilot signal to the transmitter, the channel information is implemented in a way that the receiver measures a channel and then reports the measured channel through CSI in the current mobile communication. When the aforementioned MIMO system is implemented, the channel may be defined by combination of sub channels generated among a plurality of transmitting and receiving antennas, and has a complex type as the number of antennas used for MIMO system implementation is increased. CSI reporting may be categorized into an explicit CSI reporting scheme and an implicit CSI reporting scheme in accordance with a scheme for measuring and reporting the channel information.

The implicit CSI reporting scheme is that the receiver reports information most approximate to a measured value to the transmitter without a procedure of interpreting the measured channel Various schemes for reducing signaling, which are used for CSI reporting, such as quantization of MIMO channel expressed in the form of a matrix or Singular Value Decomposition (SVD) computation, are applied to the implicit CSI reporting scheme. The implicit CSI reporting scheme is that the receiver interprets channel information instead of information on the measured channel and selects contents only required for beam generation and reports the selected contents to the transmitter, and is used in the current mobile communication system due to an advantage in that signaling overhead required for CSI reporting is less than the explicit CSI reporting scheme.

In most of the cellular system including the LTE system, the UE receives a pilot signal or reference signal for channel estimation from the eNB to calculate CSI and reports the calculated CSI to the eNB. The eNB transmits a data signal based on the CSI fed back from the UE. The CSI fed back from the UE in the LTE system includes CQI (channel quality information), PMI (precoding matrix index), and RI (rank indicator).

CQI feedback is radio channel quality information reported to provide a guide whether to apply a modulation and coding scheme (MCS) when the eNB transmits data, that is, radio channel quality information reported for link adaptation. If channel quality between the eNB and the UE is high, the UE feeds back a high CQI value, whereby the eNB will transmit data by applying a relatively high modulation order and a low coding rate. On the contrary, the UE feeds back a low CQI value, whereby the eNB will transmit data by applying a relatively low modulation order and a high coding rate.

PMI feedback is information provided to the eNB to provide a guide whether to apply a precoder if the eNB installs multiple antennas. The UE estimates a downlink channel between the eNB and the Ue from the reference signal and therefore recommends a preferable precoder applied by the eNB through PMI feedback. In the LTE system, only a linear precoder that can be expressed in the form of a matrix is considered in PMI configuration. The eNB and the UE share a codebook comprised of a plurality of precoding matrixes, and each precoding matrix within the codebook has a unique index. Therefore, the UE minimizes the amount of feedback information by feeding back an index corresponding to the most preferred precoding matrix within the codebook.

RI feedback is information on the number of preferred layers provided to the eNB for the purpose of providing a guide for the number of layers preferred by the UE. RI has a very closely related to PMI. This is because that the eNB should know a precoder to be applied to each layer depending on the number of layers. In PMI/RI feedback configuration, although PMI is defined per layer and then fed back after a PMI codebook is configured based on single layer transmission, this scheme has a drawback in that the amount of PMI/RI feedback information is significantly increased in accordance with increase of the number of transmitting layers. Therefore, in the LTE system, a PMI codebook according to the number of transmitting layers is defined. That is, for R-layer transmission, N matrixes of Nt×R size are defined in the codebook. In this case, R is the number of layers, Nt is the number of transmitting antenna ports, and N is a size of the codebook. Therefore, in the LTE system, a size of the PMI codebook is defined regardless of the number of layers. Therefore, since the number R of layers is finally equal to a rank value of the precoding matrix, the terminology RI is used.

QCL (Quasi Co-Location) between antenna ports is described as follows.

‘Quasi co-located between antenna ports’ means that large-scale properties of a signal received by a UE from a single antenna port (or a radio channel corresponding to the corresponding antenna port) can be assumed as identical to those of a signal received from the other antenna port entirely or in part. Here, the large-scale properties include Doppler spread associated with frequency offset, Doppler shift, associated with frequency offset, average delay associated with timing offset, delay spread associated with timing offset, and the like, and may further include average gain as well.

According to the above definition, a UE is unable to assume that large-scale properties are identical between NQCL (non-quasi co-located) antenna ports. In this case, the UE should independently perform a tracking procedure for obtaining frequency offset and timing offset per antenna port and the like.

On the other hand, a UE can advantageously perform the following operations between QCL (quasi co-located) antenna ports.

1) A UE can identically apply a power-delay profile, delay spread, Doppler spectrum and Doppler spread estimation result for a radio channel corresponding to a specific antenna port to a Wiener filter parameter used for channel estimation on a radio channel corresponding to another antenna port and the like.

2) After obtaining time synchronization and frequency synchronization for the specific antenna port, the UE can apply the same synchronizations to another antenna port.

3) Finally, with respect to an average gain, the UE can calculate an RSRP (reference signal received power) measurement value for each QCL antenna port into an average value.

For example, if the UE receives DM-RS based DL (downlink) data channel scheduling information, e.g., DCI format 2c through PDCCH (or E-PDCCH), the UE assumes a case of performing data demodulation after performing channel estimation on PDSCH through DM-RS sequence indicated by the scheduling information.

In such a case, if a DM-RS antenna port for DL data channel demodulation of the UE is quasi co-located with a CRS antenna port of a serving cell, the UE can improve DM-RS based DL data channel reception performance by intactly applying the large-scale properties of a radio channel estimated from a CRS antenna port of its own on channel estimation through the corresponding DM-RS antenna port.

Likewise, if a DM-RS antenna port for DL data channel demodulation of the UE is quasi co-located with a CRS antenna port of a serving cell, the UE can improve DM-RS based DL data channel reception performance by intactly applying the large-scale properties of a radio channel estimated from a CRS antenna port of the serving cell on channel estimation through the corresponding DM-RS antenna port.

Meanwhile, in the LTE system, when a DL signal is transmitted in transmission mode 10 that is a CoMP mode, it is defined that a base station configures one of QCL type A and QCL type B for a UE through a higher layer signal.

Here, the QCL type A assumes that antenna ports of CRS, DM-RS and CSI-RS quasi co-located in the rest of large-scale properties except an average gain and means that physical channel and signals are transmitted from the same node (point). On the other hand, regarding the QCL type B, maximum 4 QCL modes per UE are configured through a higher layer message to enable CoMP transmission such as DPS, JT and the like. And, which one of the 4 QCL modes is used to receive a DL signal is defined to be configured through DCI (downlink control information) dynamically.

DPS transmission in case of setting QCL type B is described in detail as follows.

First of all, a node #1 configured with N₁ antenna ports is assumed as transmitting CSI-RS resource #1, and a node #2 configured with N₂ antenna ports is assumed as transmitting CSI-RS resource #2. In this case, the CSI-RS resource #1 is included in parameter set #1 and the CSI-RS resource #2 is included in parameter set #2. Moreover, a base station configures the parameter set #1 and the parameter set #2 for a UE existing within a common coverage of the node #1 and the node #2 through a higher layer signal.

Thereafter, DPS can be performed in a manner that the base station configures the parameter set #1 for the corresponding UE using DCI in case of data (i.e., PDSCH) transmission through the node #1 and configures the parameter set #2 in case of data transmission through the node #2. In aspect of the UE, if the parameter set #1 is configured through DCI, it can assume that CSI-RS resource #1 and DM-RS are quasi co-located. If the parameter set #2 is configured through DCI, it can assume that CSI-RS resource #2 and DM-RS are quasi co-located.

Hereinafter, a communication system between vehicles based on the above-described wireless communication system will be described.

FIG. 10 is a diagram illustrating a vehicle comprising a plurality of antenna arrays. Usage frequency and usage service range of the aforementioned wireless communication system are increasing. In this case, unlike the legacy static service, needs for supporting a high Quality of Service (QoS) as well as high data throughput or high data rate is increased for a UE or user which(who) moves at a high speed.

For example, in the wireless communication system, the needs to support radio services of good quality for UEs which are moving are increased, wherein examples of the radio services include a case that a plurality of UEs or users (hereinafter, referred to as UEs), which use public transportation, desire to view multimedia while riding a vehicle, or a case that a plurality of UEs which have rode a personal vehicle travelling a highway use their respective radio communication services different from each other.

However, the legacy wireless communication system may have a limitation in providing services to UEs considering high speed movement or mobility. At this time, for service support, the system network is required to be improved to a revolution level. Also, a new system design may be required within the range that does not affect the legacy network infrastructure while maintaining compatibility with the legacy network infrastructure.

For example, a large sized antenna array may be installed in a vehicle to allow the vehicle to acquire a large array gain, whereby UEs inside the vehicle may be supported by good quality of services even in the case that the vehicle is moving at high speed. Data received through a central unit (CU) may be relayed to the UEs inside the vehicle. At this time, if the large sized antenna array is used, the vehicle may prevent communication throughput from being deteriorated by penetration loss having an average value of 20 dB, approximately. Also, since the vehicle uses Rx antennas more than the number of UEs which use the system, large array gain may easily be acquired, and Rx diversity may be acquired through a distance between Rx antennas. That is, services may be provided to UEs, which move at high speed, through the aforementioned MIMO system between vehicles without additional design of the network.

However, in spite of the aforementioned advantage, a problem occurs in that it is difficult to apply the MIMO system between the vehicles due to reasons of external appearance of the vehicle and production system construction. Also, the vehicle is a very expensive equipment compared with the legacy personal portable communication device, and may not be improved and updated easily. Also, since the vehicle should satisfy more requirements such as design concept and aerodynamic structure in addition to communication throughput, vehicle design may be restricted in view of esthetic appearance/aerodynamic aspects. For example, some of vehicle manufacturers use combined antennas, of which throughput is deteriorated as compared with a single antenna, to remove visual inconvenience of the current antenna.

However, to solve a spatial restriction of a large sized antenna array in an environment where the development and need of the communication system has been issued, vehicle installation of a distributed antenna array system for implementation of a plurality of antenna array systems is gradually introduced, and is applied considering balance with external appearance of the vehicle.

For example, referring to FIG. 10, a plurality of antennas 810, 820, 830, 840, 850, and 860 may be installed in the vehicle. At this time, the position and the number of the plurality of antennas 810, 820, 830, 840, 850, and 860 may be varied depending on a vehicle design system and each vehicle. The following configuration may equally be applied even though the position and the number of the plurality of antennas 810, 820, 830, 840, 850, and 860 installed in the vehicle are changed, and is not limited to the following embodiment. That is, the following configuration may be applied to antennas having various shapes and radiation patterns according to the position of the plurality of antennas 810, 820, 830, 840, 850, and 860.

At this time, a signal of distributed antenna units (DUs) or remote units (RUs) distributed in each of the vehicles may be controlled through a central unit (CU) 870. That is, the CU 870 of the vehicle may receive a signal from the eNB while maximizing Rx diversity by controlling the signal of the RUs 810, 820, 830, 840, 850, and 860 installed in the vehicle, and may allow radio access between the eNB and the vehicle not to be disconnected in a status that the eNB and the vehicle are moving at high speed. That is, the vehicle may be a UE having a plurality of antennas or a relay UE that relays a signal. The vehicle may provide a plurality of UEs in the vehicle with good quality of service through control and relay of the signal received through the CU 870.

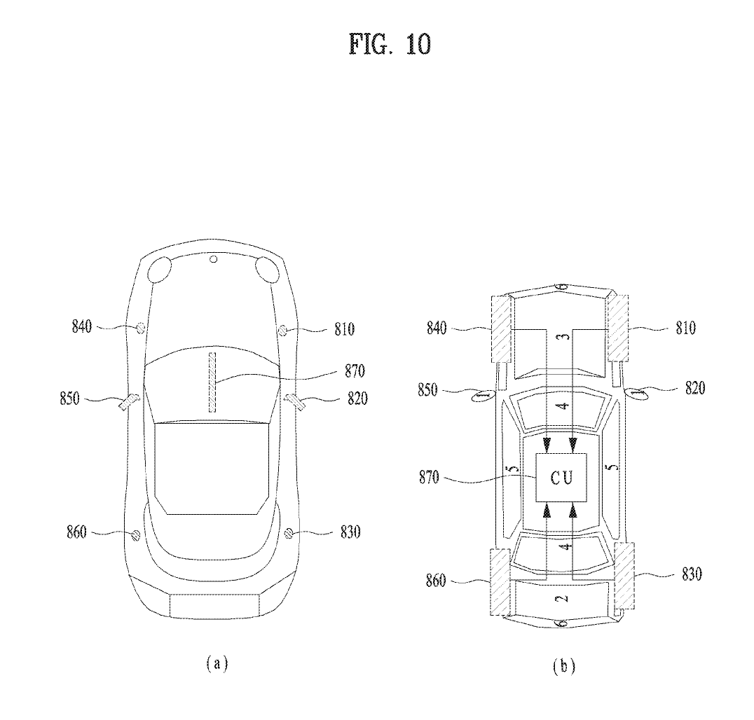

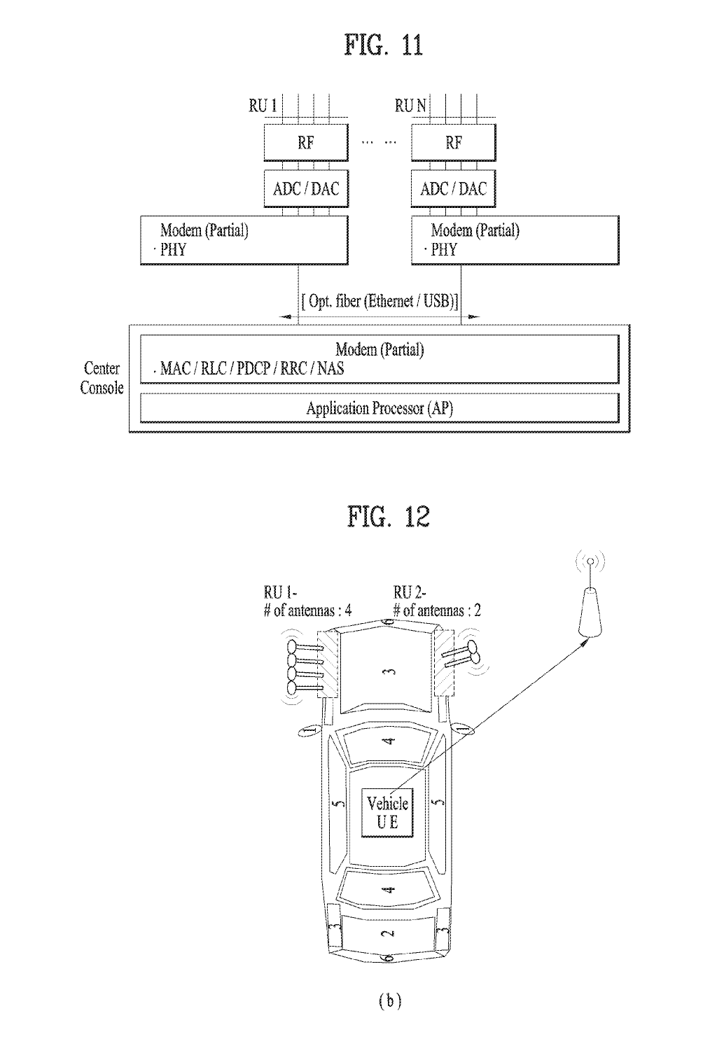

Generally, in communication, the UE comprises RRH, which includes a radio frequency (RF) and analog digital converter(ADC)/digital analog converter (DAC), a modem (including PHY, MAC, RLC, PDCP, RRC, and NAS), and an application processor (AP) in view of functional/hierarchical aspect. In the vehicle distributed antenna system, a function of a portion titled a DU has no reason for limitation to a role of an antenna (RF or RRH) module of functions/layers of the UE. This is because that some of the functions of the UE as well as the function of the RF module may additionally be given to each DU to perform a specific processing and the signal subjected to processing is delivered from the DU to the CU to enable combing processing. Therefore, the vehicle antenna system may lower RF implementation technical level (in accordance with a DU-CU implementation scenario) by appropriately distributing and allocating the functional/hierarchical modules of the UE to the DU and the CU, or may obtain implementation gain by solving a DU-CU cabling issue. In the implementation scenario according to distribution of the functional/hierarchical modules between the DU and the CU, examples in implementation of a minimum function of a module, for example, a function of a PHY layer are as illustrated in FIG. 11.

Through the vehicle distributed antenna system, the vehicle, that is, the UE may obtain downlink throughput gain through the following methods (or combination of the two methods) as compared with the legacy UE.

1. Method for increasing reliability by combining received results of respective DUs for the same information (layer) in a CU after receiving the same information from two or more DUs.

2. Method for increasing data throughput by receiving different kinds of information (layer) in DUs having large channel orthogonality.

According to the aforementioned vehicle MIMO system, actual RU received signal powers between different RUs arranged in the vehicle may be measured differently in accordance with a difference in antenna gain and beam pattern or a difference in positions of the RUs. For example, it has been searched that the antenna installed on the top of a roof of the vehicle obtains received signal power gain of 3.4 dB compared with the antenna installed on the bottom of a trunk of the vehicle, and it is already known that considerable shield loss caused by a vehicle glass medium occurs if the antenna is arranged inside the vehicle.

Meanwhile, in the vehicle distributed antenna system, a channel between the eNB and the RU may be uncorrelated for most of RUs, and fading and/or pathloss may be different for each RU. Meanwhile, the QCL condition between antenna ports, which is defined in transmission mode TM 10 for CoMP transmission, may be established between some RUs installed to be very close to each other among the RUs inside the same vehicle.

The present invention suggests a codeword-to-layer mapping (CLM) scheme for uplink data transmission, which reflects channel features of the distributed vehicle antenna system. In the vehicle distributed antenna system, since the respective RUs are physically spaced apart from each other as compared with the legacy cellular UE, antenna ports having similar features such as channel correlation, fading and pathloss are categorized into a plurality of groups. Generally, since the antenna ports which belong to the same RU have similar channel (quality) features, it may be assumed that these antenna ports constitute one group. Considering these features, the CLM scheme for the vehicle distributed antenna should be designed by reflecting antenna port grouping of the vehicle UE.

The CLM rule for vehicle distributed antenna uplink data transmission may be performed by three methods as follows in accordance with antenna port grouping features inside the vehicle UE.

1. Different codeword(s) may be allocated to each RU (or antenna port group). In a state that channel features between the eNB and the RU are different for most of the RUs, it may be more efficient in view of throughput optimization that one codeword is transmitted to one RU (or antenna port group) and the other codeword is transmitted to the other RUs (or antenna port groups) than that a plurality of codewords which use different MCS levels are mapped into the same RU (or antenna port group). That is, if two or more codewords are transmitted to the eNB through a plurality of RUs (or antenna port groups), it may be preferable that the CLM rule is determined such that two or more codewords may not be transmitted from one RU (or antenna port group).

2. One codeword may commonly be allocated to a plurality of RUs (or antenna port groups). Since the number of codewords is generally smaller than the number of layers, it is likely that one codeword may be transmitted through a plurality of different RUs. At this time, it may be preferable in view of throughput optimization that RUs having similar channel quality and features may be selected from a plurality of RUs which transmit the same codeword and then transmitted through antenna ports which belong to the same antenna port group.

3. As a combined method of the aforementioned methods 1 and 2, an individual codeword may be allocated to some RUs, and some codewords may commonly be allocated to the other RUs.

Also, to support vehicle distributed antenna uplink data transmission, it is assumed that RU selection based precoding or antenna port selection based precoding, which may be mapped into different RUs per layer, is able to be performed. Therefore, precoding in which some layer group is only mapped into some antenna port group (or RU, or RU group) may be regarded to be performed.

When RU selection based precoding or antenna port selection based precoding is applied, some layer corresponding to one codeword are transmitted to specific antenna ports, and these antenna ports transmit data through some RU or RU group only. Therefore, different MCSs may be applied by identifying codewords on a RU (or RU group) basis, whereby throughput may be optimized.

Although the present invention discloses a codeword-to-layer mapping relation, If there is a data transmission basis that may define MCS independently in addition to codword, the corresponding data transmission basis may similarly be applied to a mapping rule between the corresponding transmission basis and the layer.

Also, for convenience of description, the present invention will be described on the assumption of a structure that one UE transmits a maximum of two codewords and four layers on uplink. However, the present invention is not limited to the technology for transmitting two codewords or four layers. Particularly, as the number of RUs is increased in the vehicle distributed antenna system, different codewords may be transmitted to each RU. Since layer mapping may be performed for one codeword through antenna ports of a plurality of RUs, the number of cases for the CLM rule may be increased more remarkably than the legacy LTE, and the mapping rule may have more flexibility.

### First Embodiment—CLM Indicator

If the CLM rule of the legacy LTE system is applied to the vehicle distributed antenna system, a problem may occur in that CLM is determined by the number (ranks) of all layers regardless of the number of layers transmitted per RU.

FIG. 12 is a diagram illustrating a problem that may occur when the legacy CLM rule is applied to a vehicle distributed antenna system.

Referring to FIG. 12, the UE may transmit six SRS through two RUs, and the eNB may determine precoder and rank for uplink transmission through the SRS and notify the UE of the determined precoder and rank through an uplink grant. At this time, if the determined rank is 4, it is assumed that three layers (layer #0 to layer #2) and one layer (layer #3) have been mapped into antenna ports of RU 1 and RU 2.

Under the legacy CLM rule, since layer #0 and layer #1 are mapped into the first codeword, and layer #2 and layer #3 are mapped into the second codeword, RU 2 transmits one codeword, whereas RU 1 should transmit two codewords. According to the aforementioned description, since this transmission may cause throughput degradation, a new CLM rule is defined as suggested in Table 2 below by introducing a CLM indicator considering various mapping rules applied to the same layers and codewords.

TABLE 2

| Number | Number of | CLM | Codeword-to-layer mapping | |
|---|---|---|---|---|
| of layers | codewords | indicator | i = 0, 1, . . . , M_{symb}^{layer} − 1 | |
| 4 | 2 | 0 | x⁽⁰⁾(i) = d⁽⁰⁾(2i) | M_{symb}^{layer} = M_{symb}⁽⁰⁾/2 = M_{symb}⁽¹⁾/2 |
| | | | x⁽¹⁾(i) = d⁽⁰⁾(2i + 1) | |
| | | | x⁽²⁾(i) = d⁽¹⁾(2i) | |
| | | | x⁽³⁾(i) = d⁽¹⁾(2i + 1) | |
| | | 1 | x⁽⁰⁾(i) = d⁽⁰⁾(i) | M_{symb}^{layer} = M_{symb}⁽⁰⁾ = M_{symb}⁽¹⁾/3 |
| | | | x⁽¹⁾(i) = d⁽¹⁾(3i) | |
| | | | x⁽²⁾(i) = d⁽¹⁾(3i + 1) | |
| | | | x⁽³⁾(i) = d⁽¹⁾(3i + 2) | |
| 5 | 2 | 0 | x⁽⁰⁾(i) = d⁽⁰⁾(2i) | M_{symb}^{layer} = M_{symb}⁽⁰⁾/2 = M_{symb}⁽¹⁾/3 |
| | | | x⁽¹⁾(i) = d⁽⁰⁾(2i + 1) | |
| | | | x⁽²⁾(i) = d⁽¹⁾(3i) | |
| | | | x⁽³⁾(i) = d⁽¹⁾(3i + 1) | |
| | | | x⁽⁴⁾(i) = d⁽¹⁾(3i + 2) | |
| | | 1 | x⁽⁰⁾(i) = d⁽⁰⁾(i) | M_{symb}^{layer} = M_{symb}⁽⁰⁾ = M_{symb}⁽¹⁾/4 |
| | | | x⁽¹⁾(i) = d⁽¹⁾(4i) | |
| | | | x⁽²⁾(i) = d⁽¹⁾(4i + 1) | |
| | | | x⁽³⁾(i) = d⁽¹⁾(4i + 2) | |
| | | | x⁽⁴⁾(i) = d⁽¹⁾(4i + 3) | |
| 6 | 2 | 0 | x⁽⁰⁾(i) = d⁽⁰⁾(3i) | M_{symb}^{layer} = M_{symb}⁽⁰⁾/3 = M_{symb}⁽¹⁾/3 |
| | | | x⁽¹⁾(i) = d⁽⁰⁾(3i + 1) | |
| | | | x⁽²⁾(i) = d⁽⁰⁾(3i + 2) | |
| | | | x⁽³⁾(i) = d⁽¹⁾(3i) | |
| | | | x⁽⁴⁾(i) = d⁽¹⁾(3i + 1) | |
| | | | x⁽⁵⁾(i) = d⁽¹⁾(3i + 2) | |
| | | 1 | x⁽⁰⁾(i) = d⁽⁰⁾(2i) | M_{symb}^{layer} = M_{symb}⁽⁰⁾/2 = M_{symb}⁽¹⁾/4 |
| | | | x⁽¹⁾(i) = d⁽⁰⁾(2i + 1) | |
| | | | x⁽²⁾(i) = d⁽¹⁾(4i) | |
| | | | x⁽³⁾(i) = d⁽¹⁾(4i + 1) | |
| | | | x⁽⁴⁾(i) = d⁽¹⁾(4i + 2) | |
| | | | x⁽⁵⁾(i) = d⁽¹⁾(4i + 3) | |
| | | 2 | x⁽⁰⁾(i) = d⁽⁰⁾(i) | M_{symb}^{layer} = M_{symb}⁽⁰⁾ = M_{symb}⁽¹⁾/5 |
| | | | x⁽¹⁾(i) = d⁽¹⁾(5i) | |
| | | | x⁽²⁾(i) = d⁽¹⁾(5i + 1) | |
| | | | x⁽³⁾(i) = d⁽¹⁾(5i + 2) | |
| | | | x⁽⁴⁾(i) = d⁽¹⁾(5i + 3) | |
| | | | x⁽⁵⁾(i) = d⁽¹⁾(5i + 4) | |

The CLM rule is fixed in accordance with the number of layers in the legacy method, whereas the same number of codewords and layers may be subjected to different mapping rules through different CLM indicators in the method suggested herein.

In Table 2, it is assumed that the number of layers mapped into the first codeword is smaller than or equal to the number of layers mapped into the second codeword and combination according to various layer orders is disregarded. Particularly, for convenience, it is assumed that a maximum of two codewords are transmitted to an uplink through a maximum of six layers in accordance with MIMO antenna mode. If this assumption is not provided, the number of CLM indicators for each layer has no choice but to be increased. However, combination according to the order of layers may be solved by application of layer permutation which will be described later.

Also, although the CLM indicator is defined as an indicator indicating combination of layers per codeword in a status of the same number of codewords and ranks, its usage may be considered in the legacy LTE system as a 1-bit indicator indicating the CLM rule or not, indicated for the UE by the eNB. That is, in uplink transmission of rank 5 or less, all CLM combinations may be expressed even by the 1-bit indicator.

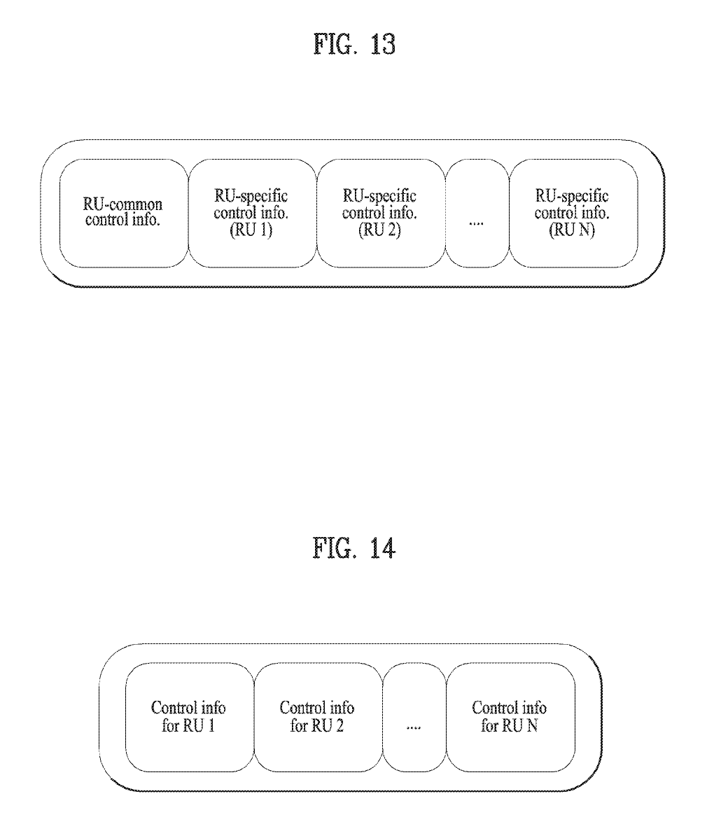

Meanwhile, if the CLM indicator is determined in the eNB, the eNB may explicitly transmit uplink control information (for example, uplink grant), which includes the CLM indicator, to the vehicle UE. FIGS. 13 and 14 are diagrams illustrating a method for providing a CLM indicator in accordance with the first embodiment of the present invention.

The eNB may transmit the CLM indicator to RU specific control information as shown in FIG. 13, and may provide the UE with individual RU control information payload including the CLM indicator as shown in FIG. 14.

On the other hand, if the CLM indicator is included in UE specific control information instead of explicitly indicating the CLM indicator through individual RU control information, the UE may implicitly know that one codeword should be transmitted through an antenna port which belongs to a plurality of RUs. Also, if the CLM indicator is not transmitted to the UE, the UE may be recognized that individual codeword(s) is(are) allocated to each RU.

Meanwhile, for determination of the aforementioned CLM indicator, a distributed antenna UE may provide the eNB with information on a CLM rule, which can be used by the UE, among the CLM rules by notifying the eNB of antenna port configuration information (or antenna port group information) per RU. According to this case, the UE may restrict a type of a CLM rule, which can be selected by the eNB through control information, whereby the eNB may lower complexity for searching for a preferred CLM rule or does not need to search for the preferred CLM rule.

For example, if a specific vehicle UE has two RUs which respectively have one antenna port and four antenna ports, the eNB may allocate two codewords to each RU. At this time, a layer mapped into the first codeword is layer #0, and layer #1 to layer #4 are allocated to the second codeword. Therefore, the UE may deliver a CLM indicator having a mapping relation of the first codeword mapped into only one layer among the CLM indicators to the eNB as control information. If this case is applied to Table 2, one CLM indicator having a mapping relation (x⁽⁰⁾(i)=d⁽⁰⁾(i)) of the first codeword mapped into only one layer exists per a total number of layers. In this case, the eNB does not need to provide the CLM indicator.

If two or more CLM rules per the number of layers are provided as control information, the eNB may still need to select a preferred one of the two or more CLM rules and feed the selected CLM rule back to the UE. However, at this time, a size of feedback information may be more reduced than the case that control information is not provided. That is, if the UE limits a candidate group (or antenna port group information) of the CLM rules provided as control information to a specific number or less, control information including the CLM indicator may be reconfigured to be suitable for its amount and then fed back.

Meanwhile, antenna port configuration information (or antenna port group information) per RU, which is provided to the eNB by the UE, is not information dynamically changed depending on time, and has a fixed property. Therefore, this information does not need to be frequently reported to the eNB, and is signaled as control information such as UE capability information once more when the UE accesses a cell, and the eNB may determine a CLM rule and precoder per RU of the vehicle UE based on the corresponding information and then provide the determined CLM rule and precoder to the UE.

### Second Embodiment—Layer Permutation

Considering a codeword-to-layer mapping order combination in addition to the CLM rule suggested in Table 2 as described above, the large number of cases of CLM may exist. To reflect this, a method for extending a table using more CLM indicators may be considered. For example, if the number of layers is 4, in addition to the CLM rule suggested in Table 2, a CLM rule in which the first codeword is mapped into layer #1 to layer #3 and the second codeword is mapped into the other layers may exist, and a CLM relation in which the first codeword is mapped into layer #0 and layer #2 or mapped into layer #2 and layer #3 may also exist. That is, as illustrated in Table 2, it is not required that the first codeword should be mapped into layer #0 or layer #0 to layer #1 and the second codeword should be mapped into the other layers.

These various CLM rules may be defined as listed in Table but signaling overhead of the eNB and/or the UE may be increased by increase of the amount of information of the CLM rule. Therefore, the present invention suggests layer permutation that considers codeword-to-layer mapping order combination as follows.

The layer permutation (or layer sorting) serves to change the order of the layers, and may be included in a precoding procedure or CLM procedure or added between CLM and precoding as a separate function block. That is, the layer permutation should be performed after CLM and before precoding. An indicator for layer permutation may also be provided to the UE together with a CLM indicator.

Symbols transmitted from the kth layer of a total of K layers according to CLM of Table 2 are expressed as x^{(k)}, k=0, . . . , K−1 which is 1×M_{symb}^{layer} vector. In this case, x^{(k)}=[x^{(k)}(0), x^{(k)}(1), . . . x^{(k)}(M_{symb}^{layer})]. Symbol vectors transmitted from all layers are expressed as K×M_{symb}^{layer} matrix X=[x^{(0)T} x^{(1)T} . . . x^{(K-1)T}]^{T} if arranged downwardly. Layer permutation is a type of K×K matrix P multiplied by this signal. The matrix P is a permutation matrix and has elements comprised of K number of 1 and K2-K number of 0, and if element (i,j) is 1, all elements in the ith row and all elements in the jth column except the element 1 are 0. Therefore, elements of 1 respectively exist in all columns, and elements of 1 respectively exist in all rows.

The suggested method applies precoding after this permutation matrix P is multiplied by X. That is, the input of precoding is changed to PX not X. It is assumed that a signal of a precoder input terminal is X′=PX. Since an inverse matrix of the permutation matrix has the same feature as that of a transposed matrix, a relation of (P⁻¹=P^{T}), X=P^{T}X′ is also established. Therefore, a precoder input terminal for a CLM output terminal is permutated by the permutation matrix P. Inversely, the CLM output terminal for the precoder input terminal is permutated by a permutation matrix P^{T}.

Layer permutation matrixes for K layers theoretically exist as much as K!=K×(K−1)×(K−2)× . . . ×1. Therefore, if the number of total layers (that is, ranks) is 4 or more, too many cases of layer permutations occur, whereby high signaling overhead may be caused. Therefore, the number of total layer permutation matrixes may be restricted by additional signaling or a specific rule. For example, the UE may previously notify the eNB of a layer permutation indicator group, which can be selected by the eNB, through a bitmap. If the eNB and the UE can know how many layers are used per RU to transmit data, the layer permutation may be limited to permutation between RUs.

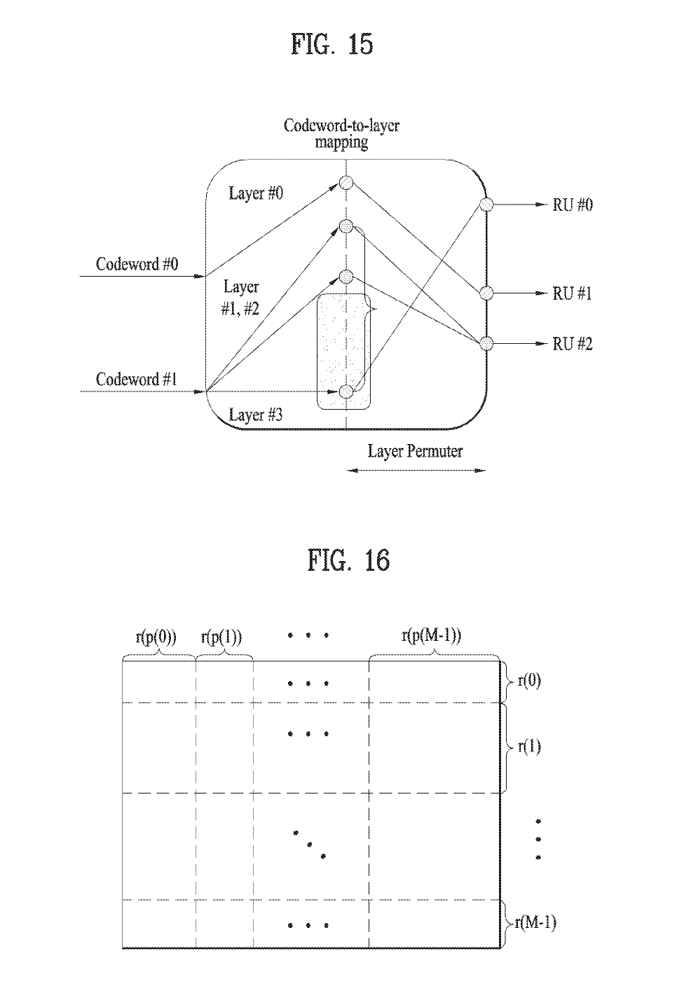

FIG. 15 is an example of layer permutation according to the second embodiment of the present invention. Particularly, in FIG. 15, it is assumed that one of four layers is mapped into RU #0, two of the four layers are mapped into RU #1, and one of the four layers is mapped into RU #2 and thus the UE has selected a CLM rule corresponding to the CLM indicator 1 of Table 2.

Referring to FIG. 15, one layer corresponding to RU #0 is to be mapped into the first codeword and the other three layers corresponding to RU #1 and RU #2 are to be mapped into the second codeword. However, since port #0 is transmitted to RU #0, port #1 is transmitted to RU #1 and ports #2 and #3 are transmitted to RU #2, if CLM corresponding to the CLM indicator 1 of Table 2 is directly applied, 1 layer of RU #0 has no option but to be mapped into the first codeword. Therefore, in this case, a permutation matrix P expressed in the following Equation 8 may be applied together with CLM of Table 2, whereby the first codeword may be transmitted through layer #0 of RU #1.

$$P = [ \begin{matrix}0 & 1 & 0 & 0 \\ 0 & 0 & 1 & 1 \\ 0 & 0 & 1 & 1 \\ 1 & 0 & 0 & 0\end{matrix} ] \qquad [ Equation 8 ]$$

In case of a vehicle distributed antenna UE, since antenna ports which belong to the same RU have similar channel features, a combination of layer permutation is limited to layer permutation (or RU based layer permutation) between RUs, whereby a layer permutation matrix may be configured using RU (or antenna port group) permutation information. According to this case, layer permutation may be limited to layer permutation of RU (or antenna port group) or RU group basis, whereby signaling overhead may be reduced or complexity for searching for optimal layer permutation by the eNB may be reduced. That is, since maximum permutations M! for M(<K) RUs (or RU groups) reduced from maximum permutations K! for K layers are used, signaling overhead and eNB complexity are reduced.

Referring to the example of FIG. 15, if RU (or RU group) based layer permutation is expressed by grouping layers as much as per-RU-rank on an RU basis, RU index {0,1,2} at the precoder input terminal may be subjected to mapping by being changed to {2,0,1} at the CLM output terminal.

This will be described by normalization. First of all, it is assumed that M RUs (RU #0, RU #1, . . . , RU #(M−1)) aligned in the order of antenna port index respectively have ranks r(0), r(1), . . . , r(M−1). At this time, when a permutation rule for M RUs is given from CLM output terminal nodes {0, 1, . . . , M−1} to precoder input terminal nodes {p(0), p(1), . . . , p(M−1)}, an input terminal and an output terminal may be defined by the permutation matrix P^{T}. In this case, p(i) is an integer between 0 or more and M−1 or less, and a relation of p(i#p(j) is established for i and j which are different from each other. The layer permutation matrix is configured using this relation as illustrated in FIG. 16.

FIG. 16 is a configuration example of an RU based layer permutation matrix according to the second embodiment of the present invention.

Referring to FIG. 16, first of all, the K×K matrix P is subjected to sequential row division as much as the number of layers mapped per RU (per-node-rank). In this case, K means a total rank.

That is, \textcircled{1} rows equivalent to r(i) are subjected to division by grouping the rows while increasing i as much as 1 by starting from 0. At this time, the divided row group is referred to as a row block, and is defined as the ith row block (i=0, . . . , M−1).

Next, \textcircled{2} columns equivalent to r(p(i)) are subjected to division by grouping the columns while increasing i as much as 1 by starting from 0 in accordance with the permutation rule. Likewise, the divided column group is referred to as a column block, and is defined as the ith column block (i=0, . . . , M−1).

Finally, \textcircled{3} r(i)×r(i) sized unit matrix is inserted to a crossed block of the ith row block and the p−1(i)th column block while increasing i as much as 1 by starting from 0, and all elements which belong to the ith row block to the other column blocks are filled with 0. In this case, p−1(i) means a value of j corresponding to p(j)=i.

If the configuration method of FIG. 16 is applied to the example shown in FIG. 15, the permutation matrix P expressed in the Equation 8 may be configured.

To replace layer permutation information with the aforementioned RU permutation information, per-RU-rank information should be signaled together with the RU permutation information. That is, to replace layer permutation feedback information, per-RU-rank information and RU based layer permutation information should be fed back to the eNB, whereby the eNB may apply exact layer permutation.

The RU permutation information may be signaled in various methods. For example, the RU permutation information may be signaled in such a manner that p(0), p(1), . . . , p(M−1) are directly expressed as bits in due order in a relation between RU mapping of the CLM output terminal and RU mapping of the precoder input terminal, for example. Alternatively, the RU permutation relation may be expressed as M×M permutation matrix Pnode, whereby index of the permutation matrix may be signaled separately. Otherwise, an RU position into which each RU is mapped may be notified by configuration of a bitmap. For example, if mapping is performed for the second RU of four RUs, 0100 may be signaled.

At this time, a variable period of a codeword mapping relation for RUs may be longer than a rank variable period. That is, although a rank may be varied in accordance with an instantaneous channel state of an individual RU and UE, the codeword mapping relation for RU may not be required to be varied even though per-RU-rank (or per-UE-rank) is varied.

For example, it is assumed in the example of FIG. 15 that a channel is changed and thus a total rank K is reduced from 4 to 3. Particularly, even though total rank and per-RU-rank information is changed and thus the CLM indicator is changed from layer combination of {1, 3} to layer combination of {1, 2}, RU permutation information (that is, CLM output terminal: {0,1,2}→precoder input terminal:{1,2,0}) is not required to be changed. Therefore, even though the RU permutation information is fed back at a period longer than that of control information such as RI, PMI, CQI, per-RU-rank, and CLM indicator information, it little affects throughput.

RU permutation information may be used as UE control information as well as feedback information. That is, the eNB may control the UE to use specific RU permutation for uplink data transmission. For example, in a state that RU #0 transmits SRS using four higher ports and RU #1 transmits SRS using two lower ports, if it is determined to be apparent that the eNB will receive more layers from RU #0, a position change such as {CLM output terminal:{0,1}→precoder input terminal:{1,0}} may be performed for mapping in Table 2.

If RU permutation control information is configured by two or more permutation schemes, the UE may feed back a preferred one of the permutation schemes received as control information. In comparison between RU permutation control information and layer permucation control information, since a rank of the UE may be changed instantaneously, layer permutation control information on various per-RU-rank combinations should be transmitted. However, since the RU permutation control information is regardless of per-RU-rank, the RU permutation control information has the amount of control information, which is very smaller than that of the layer permutation control information. Also, since RU permutation is less affected by an instantaneous channel as described above, its frequency for transmitting control information may also be reduced.

The present invention has been described based on, but not limited to, distributed antenna based vehicle communication, and may equally be applied to a general MIMO antenna system.

The present invention has been described based on, but not limited to, distributed antenna based vehicle communication, and may equally be applied to a general MIMO antenna system.

The above-described embodiments correspond to combinations of elements and features of the present invention in prescribed forms. And, the respective elements or features may be considered as selective unless they are explicitly mentioned. Each of the elements or features can be implemented in a form failing to be combined with other elements or features. Moreover, it is able to implement an embodiment of the present invention by combining elements and/or features together in part. A sequence of operations explained for each embodiment of the present invention can be modified. Some configurations or features of one embodiment can be included in another embodiment or can be substituted for corresponding configurations or features of another embodiment. And, it is apparently understandable that an embodiment is configured by combining claims failing to have relation of explicit citation in the appended claims together or can be included as new claims by amendment after filing an application.

In this disclosure, a specific operation explained as performed by an eNode B may be performed by an upper node of the eNode B in some cases. In particular, in a network constructed with a plurality of network nodes including an eNode B, it is apparent that various operations performed for communication with a user equipment can be performed by an eNode B or other networks except the eNode B. ‘eNode B (eNB)’ may be substituted with such a terminology as a fixed station, a Node B, a base station (BS), an access point (AP) and the like.

Embodiments of the present invention can be implemented using various means. For instance, embodiments of the present invention can be implemented using hardware, firmware, software and/or any combinations thereof. In the implementation by hardware, a method according to each embodiment of the present invention can be implemented by at least one selected from the group consisting of ASICs (application specific integrated circuits), DSPs (digital signal processors), DSPDs (digital signal processing devices), PLDs (programmable logic devices), FPGAs (field programmable gate arrays), processor, controller, microcontroller, microprocessor and the like.

In case of the implementation by firmware or software, a method according to each embodiment of the present invention can be implemented by modules, procedures, and/or functions for performing the above-explained functions or operations. Software code is stored in a memory unit and is then drivable by a processor. The memory unit is provided within or outside the processor to exchange data with the processor through the various means known in public.

Detailed explanation on the preferred embodiment of the present invention disclosed as mentioned in the foregoing description is provided for those in the art to implement and execute the present invention. While the present invention has been described and illustrated herein with reference to the preferred embodiments thereof, it will be apparent to those skilled in the art that various modifications and variations can be made therein without departing from the spirit and scope of the invention. For instance, those skilled in the art can use each component described in the aforementioned embodiments in a manner of combining it with each other. Hence, the present invention may be non-limited to the aforementioned embodiments of the present invention and intends to provide a scope matched with principles and new characteristics disclosed in the present invention.

### INDUSTRIAL APPLICABILITY

Although the method for transmitting an uplink signal in a distributed antenna communication system and a device for the same have been described based on the 3GPP LTE system, the method and the device are applicable to various wireless communication systems in addition to the 3GPP LTE system.

1. A method transmitting an uplink signal comprising a plurality of codewords for a user equipment (UE) having a plurality of distributed antenna units in a wireless communication system, the method comprising the steps of:
receiving, from a base station, control information for the uplink signal;
mapping the plurality of codewords into a plurality of layers in accordance with an indicator included in the control information;
precoding the layer-mapped codewords; and
transmitting the uplink signal comprising the precoded codewords to the base station,
wherein the indicator indicates one of two or more codeword-to-layer mapping rules corresponding to the number of the layers.

2. The method of claim 1, wherein the two or more codeword-to-layer mapping rules include a specific mapping rule in which one codeword is mapped into one layer and the other one codeword is mapped into the other layers.

3. The method according to claim 1, wherein the step of mapping the plurality of layers includes applying layer permutation to the layer-mapped codewords on a layer group basis, wherein the layer group is defined as a layer of a rank size per distributed antenna unit.

4. The method of claim 3, wherein the step of precoding the layer-mapped codewords includes precoding the codewords to which layer permutation is applied.

5. The method of claim 3, wherein information for the layer permutation and information on a rank size per distributed antenna unit are included in the control information.

6. The method of claim 1, further comprising the step of transmitting antenna port configuration information per distributed antenna to the base station.

7. A user equipment (UE) in a wireless communication system, the UE comprising:
a plurality of distributed antenna units; and
a processor connected with the plurality of distributed antenna units,
wherein the processor receives, from a base station, control information for an uplink signal comprising a plurality of codewords, maps the plurality of codewords into a plurality of layers in accordance with an indicator included in the control information, precodes the layer-mapped codewords, and transmits the uplink signal comprising the precoded codewords to the base station, and
wherein the indicator indicates one of two or more codeword-to-layer mapping rules corresponding to the number of the layers.

8. The UE of claim 7, wherein the two or more codeword-to-layer mapping rules include a specific mapping rule in which one codeword is mapped into one layer and the other one codeword is mapped into the other layers.

9. The UE of claim 7, wherein the processor applies layer permutation to the layer-mapped codewords on a layer group basis, and the layer group is defined as a layer of a rank size per distributed antenna unit.

10. The UE of claim 9, wherein the processor precodes the codewords to which layer permutation is applied.

11. The UE of claim 9, wherein information for the layer permutation and information on a rank size per distributed antenna unit are included in the control information.

12. The UE of claim 7, wherein the processor transmits antenna port configuration information per distributed antenna to the base station.
